(19) United States
(12) Patent Application Publication
(10) Pub. No.: US 2002/0195946 A1
(43) Pub. Date: Dec. 26, 2002

(54) Desk lamp integrated with a swivelling stage

(76) Inventor: Ming-Jen Hsiao, Dongguan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/876,026

(22) Filed: Jun. 8, 2001

(51) Int. Cl. H01J 7/44

(52) U.S. Cl. 315/56

(57) ABSTRACT

The present invention provides a desk lamp integrated with a swivelling stage, which consists of a stand, a lamp-holder, a lampshade, switchers and power cords. Wherein, said stand includes an upper and a low caps, the lamp-holder is located above the upper cap, therein there is a disk placed on the stand and fixed on the tip of axle of a gear-down motor, said disk is driven to spin by the gear-down motor placed between the upper and the low caps via the axle extended out from the hole on the upper cap; the gear-down motor, the power cord and a switcher connect to a circuit loop. When the switcher is cut in, the desk lamp carries out the lighting function, at the same time, the gear-down motor rotates the disk slowly, and one or more dolls fixed on the disk can carry out activity appearance function.

### BACKGROUND OF THE INVENTION

1. Field of the Invention

The present invention relates to a desk lamp, and more particularly to a desk lamp integrated with a swivelling stage.

2. Description of Prior Art

In accordance with the conventional desk lamps, most of them are usually put on the desk or the beside-cupboard, and take the advantages of concentrated light to meet the variety necessaries. For matching the surrounding different styles of furniture, the appearance of the desk lamps can be chaned. Additionally, striving to change in functions, the desk lamps, nothing more than, are integrated with a calendar and a clock, or combined with an adjusting switcher for adjusting the intensity of the light. But according to above-mentioned conventional desk lamps, we can find that due to lack of the activity change in style, they are appeared to dull in structure and function.

### OBJECTS AND SUMMARY OF THE INVENTION

It is therefore a main object of the present invention to provide a desk lamp integrated with a swivelling stage, thereby to increase the activity appearance function.

It is another object of the present invention to provide a desk lamp integrated with a swivelling stage, which can combine with a music device.

For archiving the above-mentioned objects, a desk lamp integrated with a swivelling stage in this present invention, which consists of a stand, a lamp-holder, a lampshade, switchers and power cords. Wherein, said stand includes an upper and a low caps, the lamp-holder is located above the upper cap, therein there is a disk placed on the stand and fixed on the tip of axle of a gear-down motor, said disk is driven to spin by the gear-down motor placed between the upper and the low caps via the axle extended out from the hole on the upper cap; the gear-down motor, the power cord and a switcher connect to a circuit loop.

Because the present invention employs above-mentioned structure, when the switcher is cut in, the desk lamp carries out the lighting function, at the same time, the disk is rotated slowly by the gear-down motor, and one or more dolls fixed on the disk can carry out activity appearance function. If coordinating with music, and under setting off of the light, the rotating disk just performs as an activity stage.

### BRIEF DESCRIPTION OF THE DRAWINGS

FIG. 1 is an exploded solid view of the present invention.

FIG. 2 is a solid view showing the combination state of the present invention.

FIG. 3 is a solid view showing the action (1) of the present invention.

FIG. 4 is a solid view showing the action (2) of the present invention.

### DETAILED DESCRIPTION OF PREFERRED EMBODIMENTS

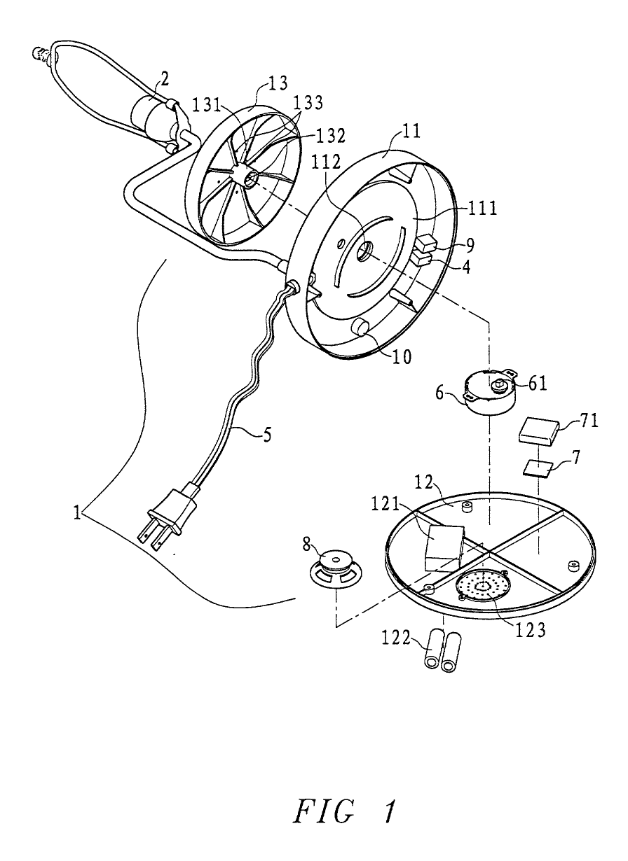

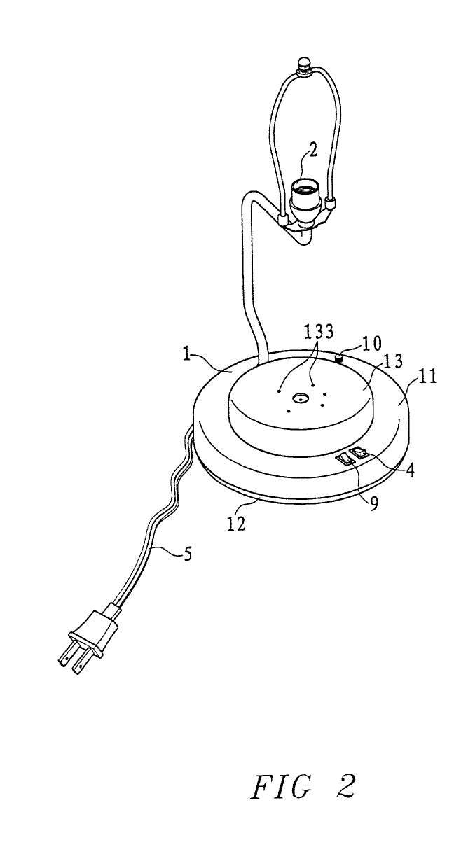

Referring to FIG. 1 and FIG. 2, the present invention provides a desk lamp integrated with a swivelling stage, which consists of a stand 1, a lamp-holder 2, a lampshade 3, a switcher 4 and cords 5.

The stand 1 includes an upper cap 11, a low cap 12 and a disk 13; wherein, the upper cap 11 has a circular recess 111 at the top central portion, and a through-hole 112 at the central point of the circular recess 111; the disk 13 extends down a square pin 131 from the bottom side with a noncircular blind hole 132 at the inside of the tip end for fitting on the below-mentioned gear-down motor 61, and has a set of eyelets 133 on the surface; said disk 13 is placed into the circular recess 11 of the upper cap 11; the low cap 12 holds on a battery box 121 containing a set of batteries 122 at the inside, and has a set of eyelets 123 at the proper portion of the bottom side.

Wherein a gear-down motor 6, a music IC 7 and a speaker 8 are located between the upper and low caps, therein the axle 61 with a cross-section coordinating to the blind hole 132 of the gear-down motor 6 fits into the disk 13 with the blind hole 132 via the through-hole 112 of the upper cap 11; the music IC 7 is fixed on the inside of the upper cap 11; and the speaker 8 is secured on the low cap 12 covering on the eyelets 123; a motor switcher 9 and a music switcher 10 are set on the upper cap 11.

Said music IC 7 is connected to the speaker 8, the battery box 121 and the music switcher 10 with the cords to form a circuit loop; the gear-down motor 6 and the motor switcher 9 are connected to the power cord 5.

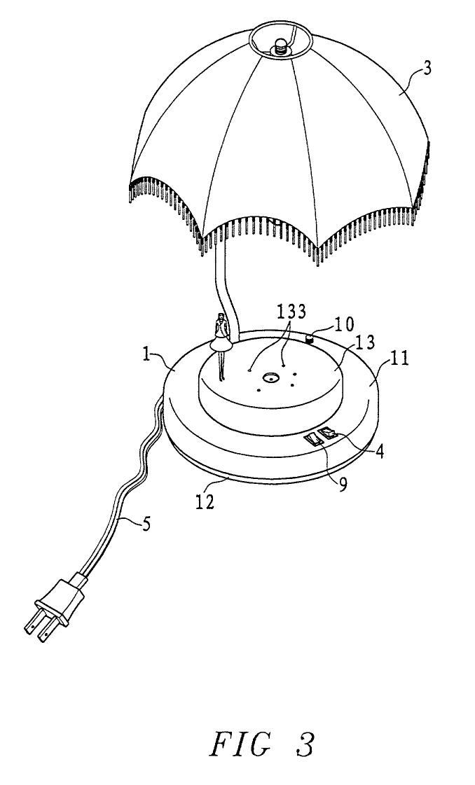

The lamp-holder 2 is located above the upper cap 11, and connected to the switcher 4 with the cords, then led to the power cord 5. (Referring to FIG. 3), the lampshade 3 covers over the lamp-holder 2 (the bulb is not drawn out in the drawing), so a desk lamp integrated with a swivelling stage is combined.

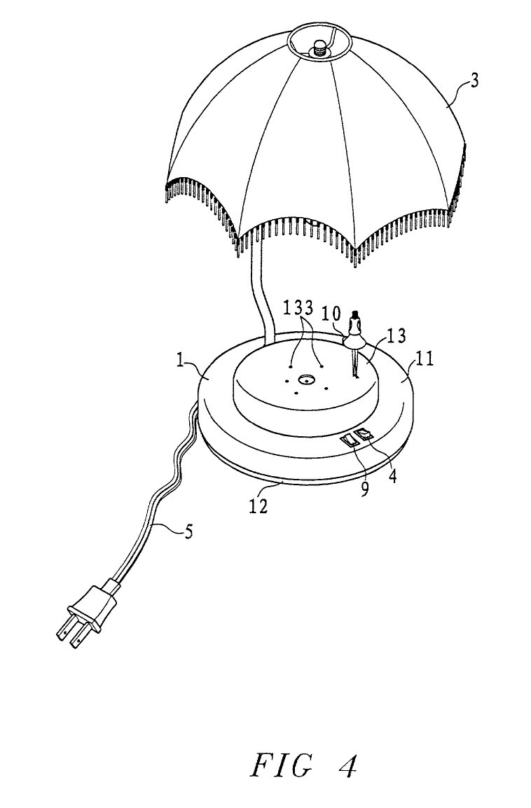

Referring to FIG. 3 and FIG. 4, when the power is cut in by turning the switcher 4 on, the desk lamp carries out the lighting function, and as switching in the motor switcher 9, the gear-down motor 6 will drive the disk 13 on the stand 1 to swivel slowly; if a doll is placed on the topside of the disk 13, you can find a activity changing appearance turns out, and co-ordinate with music as cutting the music switcher 10 in, under setting off of the light, the swivelling disk performs as an integrated music, light and activity stage. The eyelets 123 133 dug on the stand 1 enables the music sound to give out from the stand 1 easily.

Said music switcher 10 can be an adjusting switcher, in order to adjust the different intensity of sound to meet the necessaries in variety sites.

I claim:

1. A desk lamp integrated with a swivelling stage, which consists of a stand, a lamp-holder, a lampshade, switchers and power cords; wherein, said stand includes an upper and a low caps, the lamp-holder is located above the upper cap, therein there is a disk placed on the stand and fixed on the tip of axle of a gear-down motor, said disk is driven to spin by the gear-down motor placed between the upper and the low caps via the axle extended out from the hole on the upper cap; the gear-down motor, the power cord and a switcher connect to a circuit loop.

2. A desk lamp integrated with a swivelling stage as claimed in claim 1, wherein a music IC and a speaker are located between the upper and the low caps, and connected to the power with the cord.

3. A desk lamp integrated with a swivelling stage as claimed in claim 1 and claim 2, where in the stand has a circular recess formed on the top central portion.

4. A desk lamp integrated with a swivelling stage as claimed in claim 1 and claim 2, where in there is a motor switcher located on the stand.

5. A desk lamp integrated with a swivelling stage as claimed in claim 1 and claim 2, where in the music switcher is located on the stand.
